(19) United States
(12) Patent Application Publication
(10) Pub. No.: US 2009/0230807 A1
(43) Pub. Date: Sep. 17, 2009

(54) STATOR FOR ROTATING ELECTRIC MACHINE

(75) Inventors: Shingo Fubuki, Aichi-ken (JP); Kenji Harada, Aichi-ken (JP); Yasuji Taketsuna, Aichi-ken (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA, Toyota-shi (JP)

(21) Appl. No.: 12/304,421

(22) PCT Filed: Jun. 12, 2007
(86) PCT No.: PCT/JP2007/062198

§ 371 Date: Dec. 11, 2008

(30) Foreign Application Priority Data
Jun. 13, 2006 (JP) 2006-163894

(51) Int. Cl. H02K 3/12

(52) U.S. Cl. 310/201

(57) ABSTRACT

A stator includes: a stator core having a plurality of slots in a direction parallel to a rotating shaft of a rotating electric machine; a plurality of coil plate laminated bodies formed in such a manner that a plurality of coil plates each having an insulating film attached to at least one side are laminated in a radial direction; and transition members connecting the coil plate laminated bodies inserted into different ones of the slots. The stator has at least one of a first shape in which at least two transition members are provided so as to cross each other as seen from the direction parallel to the rotating shaft and a second shape in which one coil plate (128) is formed by integrally combined coil plate constituting members (200, 202) each having a substantially flat shape and being bent in a front-back direction as seen from the radial direction.

### TECHNICAL FIELD

The present invention relates to a stator for a rotating electric machine, and in particular, to a structure of a stator that reduces a loss by eddy currents.

### BACKGROUND ART

As a stator for a rotating electric machine including the stator and a rotor, conventionally, there has been disclosed a stator formed in such a manner that an integral laminated coil is inserted into a slot between a plurality of teeth provided in a stator core. In the integral laminated coil, for example, two sets of coil laminated bodies each having a plurality of linear and thin conductors laminated are integrally formed by resin molding. The thin conductors are laminated so as to be close to a sectional area of the slot in a direction orthogonal to a rotating shaft, so that an area ratio of a sectional area occupied by the coil to a sectional area of the slot. (hereinafter, referred to as a space factor) can be improved. With regard to a structure of the stator for the rotating electric machine described above, there is a technique disclosed in the following publication.

Japanese Patent Laying-Open No. 2001-178053 discloses a stator for a rotating electric machine which can be reduced in size and improved in workability in such a manner that a length of a coil end is reduced. The stator for the rotating electric machine includes a stator core, and stator coils attached to a plurality of slots formed between teeth of the stator core. The stator coil is formed in such a manner that two sets of linear and thin conductors, which are laminated, are integrally molded into one by an insulating resin. The stator coil is constituted of a laminated coil piece having connection ends formed at two ends of the conductor, and first and second connection coil pieces formed in such a manner that laminated thin conductors are integrally molded into one by an insulating resin. In the thin conductors of the laminated coil piece inserted into the plurality of slots of the stator core with the tooth being interposed therebetween, one ends are connected by the thin conductors of the first connection coil piece so as to hold the tooth, and the other ends are connected by the thin conductors of the second connection coil so as to hold the tooth with the thin conductors laminated in a radial direction of the stator core being displaced one by one in the radial direction. The stator has a feature in that the stator coil is formed while being wound around the tooth as described above.

The stator for the rotating electric machine disclosed in this publication can be reduced in size and improved in workability in such a manner that the length of the coil end is reduced.

In the stator for the rotating electric machine disclosed in the foregoing publication, however, there arises a problem that eddy currents occur by a leakage flux passing through the slot when the rotating electric machine is in operation. The leakage flux passes so as to transverse the slot in the circumferential direction. The leakage flux is generated in an increasing amount as nearer to the tip side of the tooth. Accordingly, in the laminated coil in the slot, eddy currents occur in accordance with the passage of the leakage flux. Accordingly, there arises a problem that the passage of the generated eddy currents through the thin conductors causes Joule heat to occur, thereby increasing the loss.

It may also be possible to further laminate the laminated coils in an identical turn. However, when the laminated coil has its both ends connected to a connecting coil piece, each of the laminated coil plates is connected also electrically at the connection portions. This may cause the eddy currents to entirely circulate via each of the laminated coil plates. Consequently, there arises a problem that the loss by the eddy currents cannot be suppressed.

In the stator for the rotating electric machine disclosed in the foregoing publication, none of such problems are taken into consideration. Therefore, it is impossible to suppress the loss by the eddy currents.

### DISCLOSURE OF THE INVENTION

An object of the present invention is to provide a stator for a rotating electric machine that suppresses a loss by eddy currents.

A stator for a rotating electric machine according to an aspect of the present invention is a stator for a rotating electric machine including a rotor and the stator. The stator includes: a stator core having a plurality of slots in a direction parallel to a rotating shaft of the rotating electric machine; a plurality of coil plate laminated bodies formed in such a manner that a plurality of coil plates each having an insulating member attached to at least one side are laminated in a radial direction; and connection members connecting the coil plate laminated bodies inserted into different ones of the slots. The stator has at least one of a first shape in which at least two of the connection members are provided so as to cross each other as seen from the direction parallel to the rotating shaft and a second shape in which each one of the coil plates is formed by integrally combined first member and second member each having a substantially flat shape and being bent in a front-back direction as seen from the radial direction.

According to the present invention, by a leakage flux passing in the circumferential direction in a slot, eddy currents around the magnetic flux direction occur at respective surface layer portions of the coil plates laminated in the radial direction. Even when the eddy currents occur due to the leakage flux passing the slot in the coil plate laminated body inserted into the slot, by allowing the connection members (for example, transition members) to cross each other, paths can be provided so that the eddy currents from the coil plate laminated bodies inserted into different slots flow in the opposite directions relative to each other. Accordingly, by providing a first shape so that eddy currents in opposite directions relative to each other flow in the paths of eddy currents formed because of a leakage flux over the coil plate laminated bodies inserted into different slots, the eddy currents can be cancelled. Alternatively, even when eddy currents occur, paths can be provided so that the eddy currents formed in the coil plates flow in the direction opposite to each other, by the first and second members each provided with a bent portion. Specifically, the coil plate is formed by the integrally combined first and second. members each having a portion bent in the front-back direction as seen from the radial direction. The leakage flux passes in the circumferential direction in the slot. That is, when opposing ends of the first and second members are joined, in the coil plate, an electric circulation path having a portion with a crossing portion substantially in a figure of eight as seen from the direction in which the magnetic flux passes is formed by the first and second members. Therefore, even when eddy currents occur in the surface layer portion of the coil plate by a leakage flux, a path can be provided so that the eddy currents flow in the directions opposite to each other by the crossing portion. Thus, the eddy currents can be cancelled. By canceling the eddy currents, generation of Joule heat can be suppressed. Accordingly, a stator for a rotating electric machine that suppresses a loss by eddy currents can be provided.

Preferably, the stator for the rotating electric machine has the second shape. The first member and the second member have their respective bent portions positioned near a center between openings at opposing ends of the slot.

According to the present invention, as the first member and the second member have their respective bent portions positioned near a center between openings at opposing ends of the slot, the magnitude of the eddy currents occurring at front and rear of the bent portions can be made substantially the same. The coil plate is formed by the integrally combined first and second members each having a portion bent in the front-back direction as seen from the radial direction. That is, when opposing ends of the first and second members are joined, in the coil plate, an electric path crossing substantially in a figure of eight as seen from the direction in which the magnetic flux passes is formed by the first and second members. Therefore, even when eddy currents occur in the surface layer portion of the coil plate by a leakage flux, a path can be provided so that the eddy currents flow in the directions opposite to each other by the crossing portion. Thus, by allowing the eddy currents passing in the front and rear of the bent portions to be substantially the same, the eddy currents can more surely be cancelled each other. Accordingly, the loss by the eddy currents can further be suppressed.

Further preferably, the stator for the rotating electric machine has the second shape. The coil plate has at least a first formation portion where a front-side plane of the first member and a back-side plane of the second member are in close contact with each other, and a second formation portion where a back-side plane of the first member and a front-side plane of the second member are in close contact with each other.

According to the present invention, when opposing ends of the first and second members are joined, in the coil plate, an electric path crossing substantially in a figure of eight as seen from the direction in which the magnetic flux passes is formed by the first and second members. Thus, a path can be provided so that the eddy currents flow in the directions opposite to each other. Furthermore, by the formation of the first and second formation portions, the first and second portions will be in close contact with each other, and therefore the coil plate will not become large in size in the radial direction. Accordingly, an increase in the size of the stator can be suppressed.

Further preferably, the stator for the rotating electric machine has the first shape. The coil plate is formed by two sets of laminated coil plate groups formed in such a manner that a plurality of laminated coil plates having substantially same shape as the coil plate as seen from the lamination direction are laminated. The plurality of connection members are two connection members respectively connected to the two sets of laminated coil plate groups. The two connection members respectively connect the laminated coil plate groups and two sets of laminated coil plate groups of an adjacent turn.

According to the present invention, by providing two connection members connecting to the laminated coil plate groups of the adjacent turn so that they cross each other, it becomes possible to allow an eddy current to flow in a direction from the laminated coil plate group of one turn toward the connection member, and further, an eddy current to flow in a direction from the laminated coil plate group of the other turn toward the connection member. That is, paths can be provided so that the eddy currents from the adjacent laminated coil plate groups inserted into different slots flow in the opposite directions relative to each other. Thus, the eddy currents can be canceled, whereby generation of Joule heat can be suppressed and the loss by the eddy currents can be suppressed.

Further preferably, the two connection members are inserted at a position on a center side of the rotating shaft, at least in the slot.

According to the present invention, the leakage flux tends to occur in an increasing amount as nearer to the axial center side. Accordingly, by providing the first shape on the center side of the rotating shaft, the eddy currents occurring in a large amount can be cancelled. Thus, generation of Joule heat can be suppressed and the loss by the eddy currents can be suppressed.

Further preferably, a coil of an identical turn is formed by the coil plates.

According to the present invention, by providing the second shape to the coil plates forming the coil of an identical turn, the second shape can be formed in each of the coil plate for each turn. Therefore, the eddy currents respectively occurring in the coil plates for each turn can be cancelled, whereby generation of Joule heat can further be suppressed. Accordingly, a loss by the eddy currents can further be suppressed.

Further preferably, the coil plates are inserted at a position on a center side of the rotating shaft, at least in the slot.

According to the present invention, the leakage flux tends to occur in an increasing amount as nearer to the axial center side. Accordingly, by providing the first or second shape on the center side of the rotating shaft, the eddy currents occurring in a large amount can be cancelled. Thus, generation of Joule heat can be suppressed and the loss by the eddy currents can be suppressed.

Further preferably, an end of the coil plate and an end of the connection member are joined to each other using a paste-like joining material containing a metal nanoparticle coated with an organic substance and an organic solvent.

According to the present invention, the joining portion of the coil plate end and the connection member (e.g., a transition member) is joined using a paste-like joining material containing a metal nanoparticle coated with an organic substance and an organic solvent. As for the joining material, when the organic substance serving as a protective layer is decomposed by application of heat, the metal nanoparticle starts sintering at a low temperature. Therefore, it becomes possible to allow the sintering temperature to be lower than a melting temperature of an insulating material. On the other hand, after the sintering, the metal nanoparticle is in a metal bonding state and is not melted until the temperature approaches a eutectic temperature of metal and a material for the coil plate (e.g., about 1000° C. for a eutectic temperature of silver and copper). Using such a joining material to join the joining portion, the temperature at the time of joining becomes lower than the melting temperature of the insulating material. Therefore, deterioration in an insulating performance of the insulating member can be suppressed. Furthermore, after joining, the melting temperature of the joining portion becomes sufficiently higher than the heat generated when the rotating electric machine is in operation. Therefore, deterioration in the joining strength can be suppressed.

Further preferably, the joining material sinters at a temperature lower than a melting temperature of an insulating member used for the stator.

According to the present invention, as the joining material sinters at the temperature lower than the melting temperature of the insulating material used for the stator, heat is not applied to the stator until the insulating material is melted at the time of joining. Therefore, deterioration in the insulating performance by the heat at the time of joining can be suppressed.

Further preferably, the metal nanoparticle is a nanoparticle of a metal being one of gold, silver, copper, and platinum.

According to the present invention, by using the paste-like joining material containing metal nanoparticle of one of gold, silver, copper and platinum, heat is not applied to the stator until the insulating material is melted at the time of joining. Therefore, deterioration in the insulating performance at the time of joining can be suppressed.

Further preferably, the insulating member is one of an insulating film and a coating film of insulation coating.

According to the present invention, by laminating the coil plates so that one of an insulating film and a coating film of insulation coating is interposed therebetween, the coil plates can be more surely insulated from each other by the insulation film or the coating film. By allowing the insulation film and the coating film to be as thin as possible, the insulating performance and the space factor are allowed to be compatible.

### BRIEF DESCRIPTION OF THE DRAWINGS

FIG. 1 is a perspective view of a stator according to a first embodiment.

FIG. 2 is a perspective view showing coil plates and transition members incorporated to a tooth.

FIG. 3 shows flows of magnetic fluxes between a rotor and the stator.

FIGS. 4A and 4B are perspective views showing the coil plates and the transition member in a first embodiment.

FIGS. 5A and 5B show paths of eddy currents in the coil plates.

FIG. 6 shows an appearance of a U-shaped coil plate laminated body in a second embodiment.

FIG. 7 is an illustration (No. 1) showing the structure of transition members in the second embodiment.

FIG. 8 is an illustration (No. 2) showing the structure of transition members in the second embodiment.

FIG. 9 shows paths of eddy currents in a coil plate laminated body.

FIG. 10 shows paths of eddy currents in coil plate laminated bodies and the transition members.

### BEST MODES FOR CARRYING OUT THE INVENTION

Hereinafter, an embodiment of the present invention is described with reference to the drawings. In the following description, identical parts are denoted by identical reference symbols. Designations and functions thereof are also the same. Accordingly, detailed description thereof is not repeated.

### First Embodiment

A stator according to the present embodiment is a stator for a rotating electric machine constituted of the stator and a rotor including a permanent magnet. In the present embodiment, the stator is a stator for a three-phase AC (Alternating Current) synchronous rotating electric machine in which the number of poles is 21. However, the present invention should be applied to any stator with wound coils, and the number of poles is not particularly limited to 21. Furthermore, the present invention is not limitedly applied to the stator for the three-phase AC synchronous rotating electric machine.

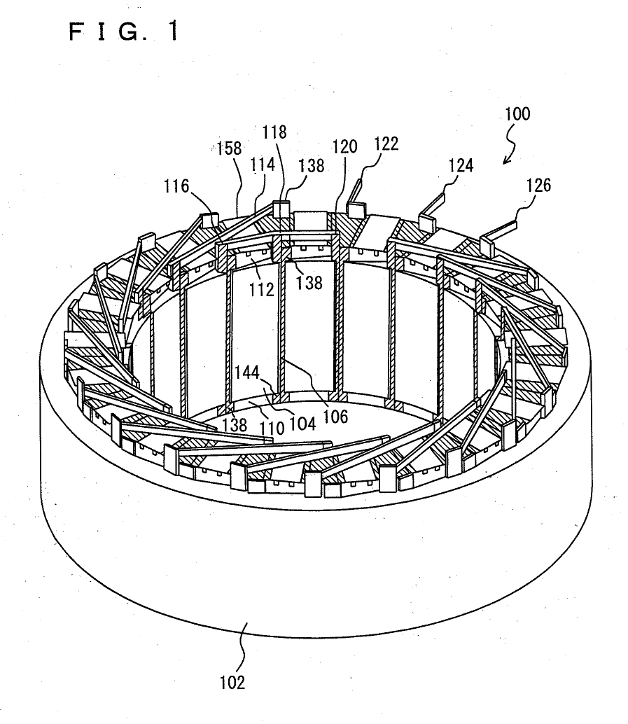

As shown in FIG. 1, a stator 100 is constituted of a stator core 102, coil plate laminated bodies 138 and 144, transition member laminated bodies 110 and 112, and bus bars 114. Transition member laminated bodies 110 and 112 are held by a holding member 158.

Stator core 102 is formed into a hollow cylindrical shape. In stator core 102, through slots 106 extending in a direction parallel with a rotating shaft are formed in a predetermined number along a circumferential direction of stator core 102. In stator core 102, further, teeth 104 are formed in a predetermined number between slots 106 so as to be opposed to an axial center of the rotating shaft. The predetermined number corresponds to the number of poles. In the present embodiment, the number of slots 106 to be formed and the number of teeth 104 to be formed are 21, respectively. In the present embodiment, stator core 102 is formed in such a manner that a plurality of electromagnetic steel plates are laminated.

Coil plate laminated bodies 138 and 144 are inserted into slot 106 formed in stator core 102. Coil plate laminated bodies 138 and 144 are formed in such a manner that a plurality of I-shaped coil plates are laminated in the radial direction. It is to be noted that coil plate laminated bodies 138 and 144 are only required to be laminated from a back yoke side toward an axial center side of stator core 102, while the lamination is not particularly limited to the radial direction. For example, coil plate laminated bodies 138 and 144 may have such a configuration that a plurality of I-shaped coil plates are laminated so that a width direction of the coil plates is orthogonal to a wall face of tooth 104 in slot 106. In the present embodiment, while each coil plate is described to have an I-shape, its shape is not particularly limited to an I-shape as long as a portion inserted into the slot is in an I-shape. For example, the coil plate may be in a U-shape.

An insulating film is attached to at least one side of the I-shaped coil plate. It is to be noted that a coating film of insulation coating may be attached in place of the insulating film. A material for the insulating film is not particularly limited as long as the insulating film has a thickness capable of ensuring insulation between the coil plates. The insulating film is a polyimide film, for example. Coil plate laminated bodies 138 and 144 are formed in such a manner that the coil plates are laminated with the insulating film interposed therebetween.

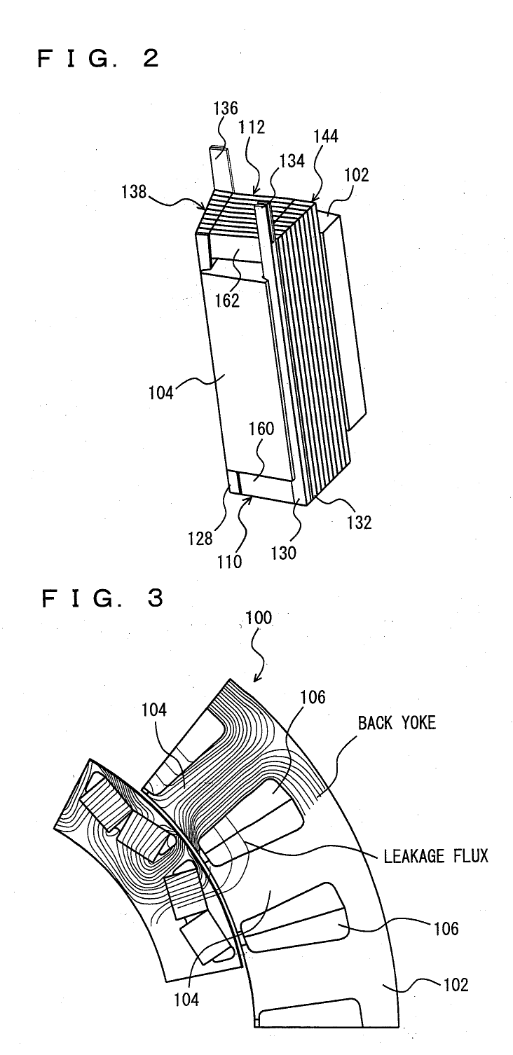

As shown in FIG. 2, among two coil plate laminated bodies 138 and 144 inserted into slots 106 positioned on opposing sides of each tooth 104, coil plate laminated bodies 138 and 144 adjacent to identical tooth 104 are connected to each other by transition member laminated bodies 110 and 112. Transition member laminated body 112 is connected to tooth 104 on its top side as seen in FIG. 2. Transition member laminated body 110 is incorporated to tooth 104 on its bottom side as seen in FIG. 2. Coil ends are formed by transition member laminated bodies 110 and 112.

Transition member laminated bodies 110 and 112 are respectively formed by a plurality of transition members 160 and 162 being laminated. Transition members 160 and 162 connect between the ends of coil plates forming two coil plate laminated bodies 138 and 144 positioned on the opposing sides of tooth 104 (i.e., inserted into different slots).

Transition member 160, being a constituent of transition member laminated body 110, connects coil plates 128 and 130 of an identical turn. Transition member 162, being a constituent of transition member laminated body 112, connects coil plates 128 and 132 of adjacent turns.

Thus, by transition member laminated bodies 110 and 112 being incorporated to two coil plate laminated bodies 138 and 144 positioned on the opposing sides of tooth 104, a coil is spirally wound around the tooth by a predetermined number of turns (ten turns in the present embodiment). It is to be noted that winding directions of the coils wound around respective teeth 104 are all the same.

Herein, ends of a coil wound around tooth 104 by ten turns are: a coil plate end 134 on the side closest to the shaft center and being connected to none of transition members 162; and a coil plate end 136 on the side farthest from the shaft center and being not connected to transition member 162.

Referring again to FIG. 1, to each of these coil plate ends, one end of bus bar 114 is connected. The other end of bus bar 114 is connected to an end of a coil that is wound around another teeth and that is of an identical phase (i.e., a coil plate laminated body inserted into a different slot). Thus, in stator core 102, coils of ten turns respectively corresponding to U phase, V phase and W phase are wound around respective teeth.

Terminal members 122 to 126 are provided at the ends of coils of respective phases. Here, coil plate end 116 and terminal member 122 correspond to the ends of U-phase coil, coil plate end 118 and terminal member 124 correspond to the ends of V-phase coil, and coil plate end 120 and terminal member 126 correspond to the ends of W-phase coil. Coil plate ends 116 to 120 are connected to each other. It is to be noted that coil plate ends 116 to 120 may not be connected to each other and a terminal member may be provided to each end.

The coil plate ends are connected to transition members 160 and 162 and bus bar 114 using a joining material. In the present embodiment, the joining material is a paste-like joining material containing a metal nanoparticle coated with an organic substance and an organic solvent (hereinafter, referred to as a metal nanoparticle paste). The metal nanoparticle is a nanoparticle of metal, e.g., one of gold, silver, copper and platinum. In the present embodiment, description will be given of use of, for example, a paste-like joining material containing a silver nanoparticle coated with an organic substance and an organic solvent (hereinafter, referred to as a silver nanoparticle paste). As for the silver nanoparticle paste, when the organic substance serving as a protective layer is decomposed by application of heat, the silver nanoparticle starts sintering at a low temperature. Therefore, the sintering temperature is low, i.e., about 260° C., which is lower than a melting temperature of an insulating material such as PPS (polyphenylene sulfide). On the other hand, after the sintering, the silver nanoparticle is in a metal bonding state and is not melted until the temperature approaches a eutectic temperature (about 1000° C.) of metal silver and copper which is a material for the coil plate. It is to be noted that a joining material containing the metal nanoparticle is a well-known technique; therefore, detailed description thereof will not be given.

A multipoint simultaneous joining process is performed by applying pressure so as to sandwich in the radial direction the coil ends of all the coil plate laminated bodies, having bus bars 114 or terminal members 122 to 126 and transition member laminated bodies 110 and 112 incorporated, and increasing the temperature.

By the increase in the temperature, the protective layer coating the silver nanoparticle contained in the silver nanoparticle paste is decomposed, and the silver nanoparticle sinters. By the application of the pressure, gas and the like in the paste generated by the decomposition of the protective layer are eliminated from the joining portion. The joining portion is joined by metal bonding of the sintering of the silver nanoparticle paste. Therefore, after the joining process, the joining portion is not melted until the temperature is increased to about 1000° C. corresponding to a melting point of metal silver. It is to be noted that the protective layer with which the silver nanoparticle is coated is decomposed at about 260° C.; therefore, the metal nanoparticle sinters at a low temperature after the protective layer is decomposed at about 260° C. Accordingly, the application of the heat is continued until the temperature reaches a predetermined temperature of about 260° C. which is lower than a temperature at which an insulating film applied to the coil plate or resin insulator 140 is melted.

A mold process is performed by injection molding of resin or the like to the coil end portion of stator 100 after the joining is completed. Here, stator core 102 is coated with resin (not shown), except for the outer peripheral face and the terminals of terminal members 122 to 126.

In the rotating electric machine including stator 100 structured as described above and a rotor (not shown), when AC power is supplied to each of terminal members 122 to 126, a magnetic field corresponding to the supplied power is generated. The rotor obtains a rotating force on the basis of the generated magnetic field, and rotates thereby.

Here, as shown in FIG. 3, a leakage flux passes along the circumferential direction in slot 106. Accordingly, in each of the coil plates constituting coil plate laminated bodies 138 and 144 laminated in the radial direction in slot 106, eddy currents corresponding to passage of the leakage current occur. As shown in FIG. 3, the leakage flux tends to occur in an increasing amount as nearer to the tip side of tooth 104. There exists a problem that the eddy currents generated by the passage of leakage flux pass through the coil plate laminated bodies, whereby Joule heat is generated and the loss becomes greater.

This problem may possibly be addressed by further laminating coil plates forming an identical turn. However, when coil plates has their both ends connected to transition members 160 and 162, each of the laminated coil plates is connected also electrically at the connection portions. This may cause the eddy currents to entirely circulate via each of the laminated coil plates. Consequently, there may be a case where the loss by the eddy currents cannot be suppressed.

Here, the present invention is characterized in that stator 100 has such a shape in which one coil plate is formed by integrally combined first and second members each having a substantially flat shape and being bent in the front-back direction as seen from the radial direction. This shape formed by the integrally combined first and second members corresponds to the aforementioned “second shape”.

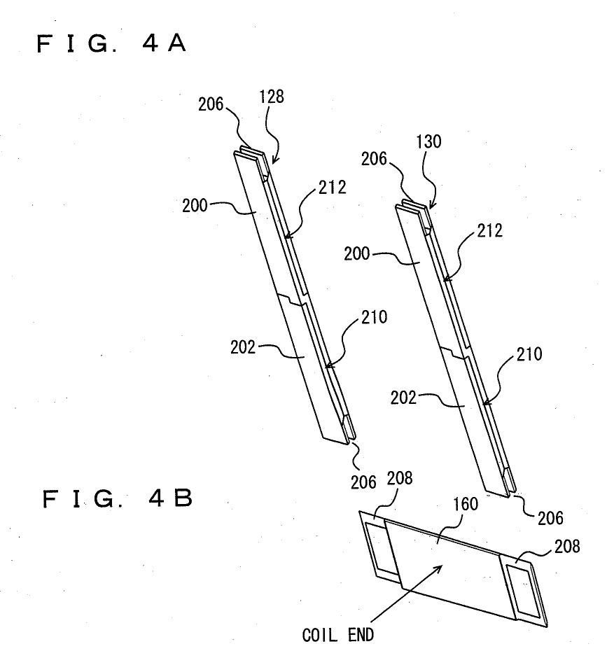

More specifically, as shown in FIGS. 4A and 4B, I-shaped coil plates 128 and 130 forming an identical turn are each formed by integrally combined two coil plate constituting members 200 and 202 having substantially flat shape. It is to be noted that coil plate constituting members 200 and 202 respectively correspond to the first member and the second member. Coil plate constituting members 200 and 202 each have a portion bent in the front-back direction as seen from the radial direction (i.e., the lamination direction).

Coil plates 128 and 130 each have at least: a formation portion 210 where a front-side plane (axial center side: left side in FIGS. 4A and 4B) of coil plate constituting member 200 and a back-side plane (back yoke side: right side in FIGS. 4A and 4B) of coil plate constituting member 202 are in close contact with each other; and a formation portion 212 where a back-side plane of coil plate constituting member 200 and a front-side plane of coil plate constituting member 202 are in close contact with each other. It is to be noted that coil plates 128 and 130 are only required to have a crossing portion as seen at least from the direction in which magnetic fluxes pass (the circumferential direction of the slot).

The bent portions of coil plate constituting members 200 and 202 are each provided with a notch portion formed to match the bent portion formed in the other coil plate constituting member. Combining coil plate constituting members 200 and 202 so that their notch portions and bent portions match each other, integrated and substantially flat coil plates 128 and 130 are formed.

Further, an insulating film is attached to at least one side of coil plate constituting members 200 and 202. It is to be noted that a coating film of insulation coating may be attached in place of the insulating film. The insulating film is applied to at least one of two opposed faces in a thickness direction of coil plate constituting members 200 and 202.

The bent portions of coil plate constituting members 200 and 202 are provided at a position near the center between openings at opposing ends of slot 106.

By combining coil plate constituting members 200 and 202, at opposing end portions 206 of coil plates 128 and 130, fitting portions corresponding to the shape of respective ends of transition members 160 and 162 are formed. In the present embodiment, transition member 162 is fitted to two fitting portions in the bottom direction of FIGS. 4A and 4B, while transition member 160 is fitted to two fitting portions in the top direction of FIGS. 4A and 4B.

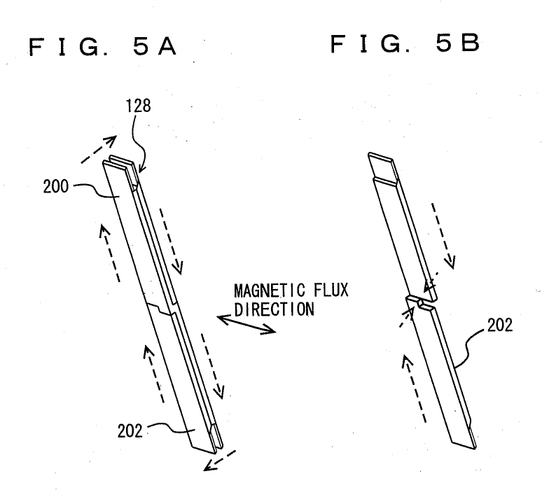

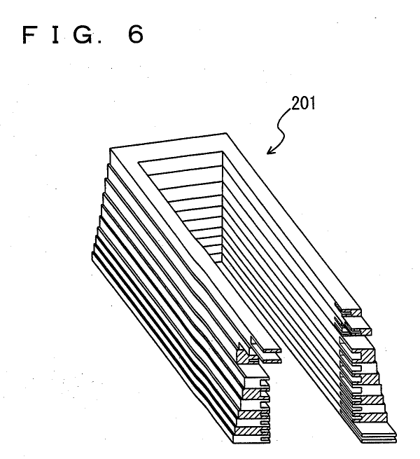

Referring to FIGS. 5A and 5B. the function of the stator for the rotating electric machine according to the present embodiment having the above-described structure will be described.

By the supply of electric power to the stator, a magnetic field is generated and a rotor rotates. Along with the generation of the magnetic flux, a leakage flux passes in the circumferential direction in slot 106. Here, to coil plate 128 in slot 106, the magnetic flux passes in the direction shown in FIG. 5A. Accordingly, in coil plate constituting members 200 and 202, eddy currents flow around the direction in which the magnetic flux passes, via the joining portions with transition members 160 and 162, as shown by the dashed-line arrows in FIG. 5A. Here, the eddy currents flow through the surface layer portion of coil plate 128. Therefore, by coil plate constituting members 200 and 202, an electric circulation path having a portion crossing substantially in a figure of eight as seen from the direction in which the magnetic flux passes is formed.

When the eddy currents pass through the front layer portion of coil plate 128, in coil plate constituting member 202, as shown by the dashed-line arrows in FIG. 5B, eddy currents flow in opposite directions by the bent portion of coil plate constituting member 202. Thus, the eddy currents are cancelled. By the cancellation of the eddy currents, generation of Joule heat is suppressed and the loss by the eddy currents is suppressed.

As above, according to the stator for the rotating electric machine according to the present embodiment, even when eddy currents occur in the coil plate laminated body inserted into a slot by a leakage flux passing through the slot, a path can be provided by the bent portion of the coil plate constituting member so that eddy currents flow in directions opposite to each other. Thus, the eddy currents can be cancelled. By the cancellation of the eddy currents, generation of Joule heat is suppressed. Accordingly, the stator for the rotating electric machine that suppresses the loss by the eddy currents can be provided.

By the provision of the bent portions of the coil plate constituting members at the positions near the center between the openings at the opposing ends of the slot, the magnitude of the eddy currents occurring at front and rear of the bent portions can be made substantially the same. As a result, the eddy currents can more surely be cancelled each other. Accordingly, the loss by the eddy currents can further be suppressed.

As the formation portions are formed so that the coil plate constituting members are in close contact with each other, the size of the coil plate in the radial direction is not increased. As a result, an increase in size of the stator can be suppressed.

The joining portion of the coil plate end and the transition member is joined using the paste-like joining material containing a silver nanoparticle coated with an organic substance and an organic solvent. In the joining material, when the organic substance serving as a protective layer is decomposed by application of heat, the silver nanoparticle starts sintering at a low temperature. Therefore, the sintering temperature can be made lower than a melting temperature of an insulating material. On the other hand, after the sintering, the silver nanoparticle is in a metal bonding state and is not melted until the temperature approaches a eutectic temperature (about 1000° C.) of silver and a material for the coil plate. Using such a joining material to join the joining portion, the temperature at the time of joining becomes lower than the melting temperature of the insulating material. Therefore, deterioration in an insulating performance of the insulating member can be suppressed. Furthermore, after joining, the melting temperature of the joining portion becomes sufficiently higher than the heat generated when the rotating electric machine is in operation. Therefore, deterioration in the joining strength can be suppressed.

As the joining material sinters at the temperature lower than the melting temperature of the insulating material used for the stator, heat is not applied to the stator until the insulating material is melted at the time of joining. Therefore, deterioration in the insulating performance by the heat at the time of joining can be suppressed.

By laminating the coil plates so that one of an insulating film and a coating film of insulation coating is interposed therebetween, the coil plates can be more surely insulated from each other by the insulation film or the coating film. By allowing the insulation film and the coating film to be as thin as possible, the insulating performance and the space factor are allowed to be compatible.

Preferably, the shape formed by coil plate constituting members 200 and 202 is provided on the axial center side. Thus, in the portion where leakage flux occurs in a large amount, the flow of eddy currents can be cancelled and whereby generation of Joule heat can further be suppressed. Accordingly, the loss by the eddy currents can be suppressed.

Alternatively, the shape formed by coil plate constituting members 200 and 202 may be provided in every coil plate for each turn. Thus, the eddy currents can be cancelled in each turn to further suppress generation of Joule heat. Accordingly, the loss by the eddy currents can be suppressed.

### Second Embodiment

Hereinafter, a stator for a rotating electric machine according to a second embodiment of the present invention will be described. The stator for the rotating electric machine according to the present embodiment is different from the above-described stator for the rotating electric machine according to the first embodiment in that it includes a U-shaped coil plate instead of the I-shaped coil plates and transition member 160. The other configurations are the same as those of above-described stator 100 for the rotating electric machine according to the first embodiment. They are denoted by identical reference symbols. Their functions are also the same. Accordingly, detailed description thereof is not repeated.

In the present embodiment, as shown in FIG. 6, a plurality of U-shaped coil plates are laminated to form coil plate laminated body 201. Opposing ends of coil plate laminated body 201 are respectively inserted into slots 106 positioned at opposing sides of tooth 104, so that coil plate laminated body 201 is incorporated to stator core 102 by bridging over tooth 104.

To the opposing ends of coil plate laminated body 201, a transition member laminated body 112 is incorporated. Coil plate laminated body 201 is formed by lamination of a plurality of coil plates corresponding to each turn. As transition member laminated body 112 is incorporated, connection is established with the end of coil plate laminated body of an adjacent turn. Thus, the coils in a predetermined number of turns are wound around tooth 104.

The plurality of coil plates corresponding to each turn are formed by a plurality of laminated coil plate groups. The plurality of laminated coil plate groups are formed by lamination of a plurality of U-shaped laminated coil plates. An insulation film is attached to at least one side of the laminated coil plate. It is to be noted that a coating film. of insulation coating may be attached in place of the insulating film. The laminated coil plate and the coil plate are formed by lamination so that an insulating film is interposed therebetween.

The present embodiment is characterized in that stator 100 has a shape in which at least two connection members are provided so as to cross each other as seen from a direction parallel to the rotating shaft. This shape in which at least two connection members are provided so as to cross each other corresponds to the aforementioned “first shape”.

More specifically, a coil plate is formed by two sets of laminated coil plate groups formed in such a manner that a plurality of laminated coil plates having substantially the same shape as the coil plate as seen from the lamination direction are laminated. The plurality of transition members are two transition members respectively connected to the two sets of laminated coil plate groups. The two transition members respectively connect the laminated coil plate groups and two sets of laminated coil plate groups of an adjacent turn. Here, the two transition members are provided so that they cross each other as seen from a direction parallel to the rotating shaft.

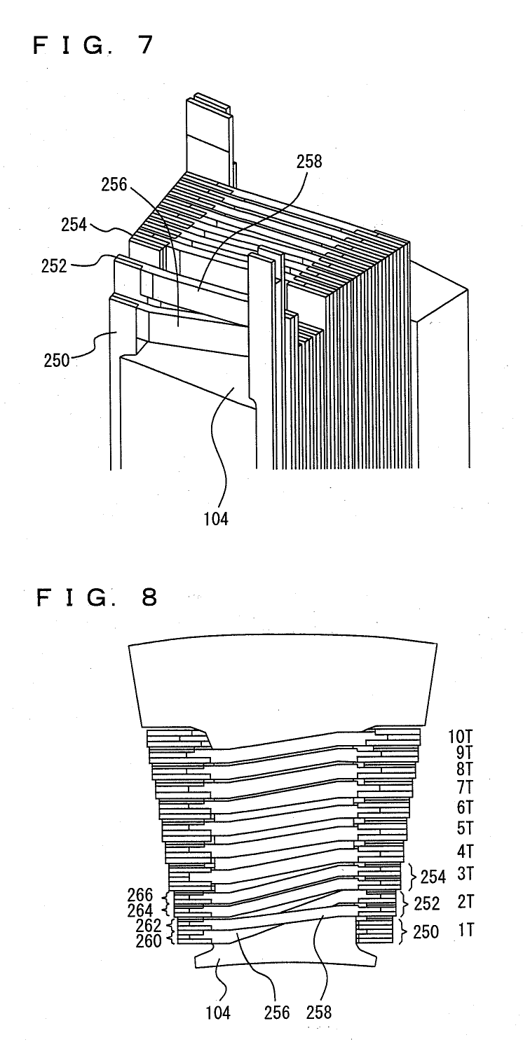

As shown in FIGS. 7 and 8, a U-shaped coil plate 250 inserted on the very tip side of tooth 104 is the coil plate of the first turn (hereinafter also referred to as 1T). Coil plate 250 is formed by a plurality of coil plate groups 260 and 262. A plurality of U-shaped laminated coil plates, which are substantially in the same shape as coil plate 250 as seen from the lamination direction, are laminated to form respective laminated coil plate groups 260 and 262. It is to be noted that part of laminated coil plates among laminated coil plate groups 260 and 262 are provided with notch portions at their ends, whereby concave shapes to which ends of transition members can fit are formed at the ends of the U-shaped coil plate. The joining portion of the coil plate end and the transition member is joined using the above-described paste-like joining material, and a specific description thereof will not be repeated herein.

U-shaped coil plate 252 is the coil plate of the second turn (hereinafter also referred to as 2T). Coil plate 252 is formed by laminated coil plate groups 264 and 266. U-shaped coil plate 254 is the coil plate of the third-turn (hereinafter also referred to as 3T).

Here, coil plate 250 of 1T and coil plate 252 of 2T are connected by two transition members 256 and 258. Two transition members 256 and 258 connect two sets of laminated coil plate groups 260 and 262 and two sets of laminated coil plate groups 264 and 266 of an adjacent turn. That is, transition member 256 connects laminated coil plate group 260 of 1T and laminated coil plate group 266 of 2T. Transition member 258 connects laminated coil plate group 262 of 1T and laminated coil plate group 264 of 2T.

While it has been assumed in the present embodiment that the crossing shape of the transition members are provided in transition members 256 and 258 between 1T and 2T, it is not so specifically limited. For example, it may also be possible to provide a crossing shape in two transition members connecting turns subsequent to 2T.

Also, while it has been described in the present embodiment that transition member 258 is positioned on the axial outward side relative to transition member 256, it may not so limited and transition member 256 may be positioned on the axial outward side relative to transition member 258.

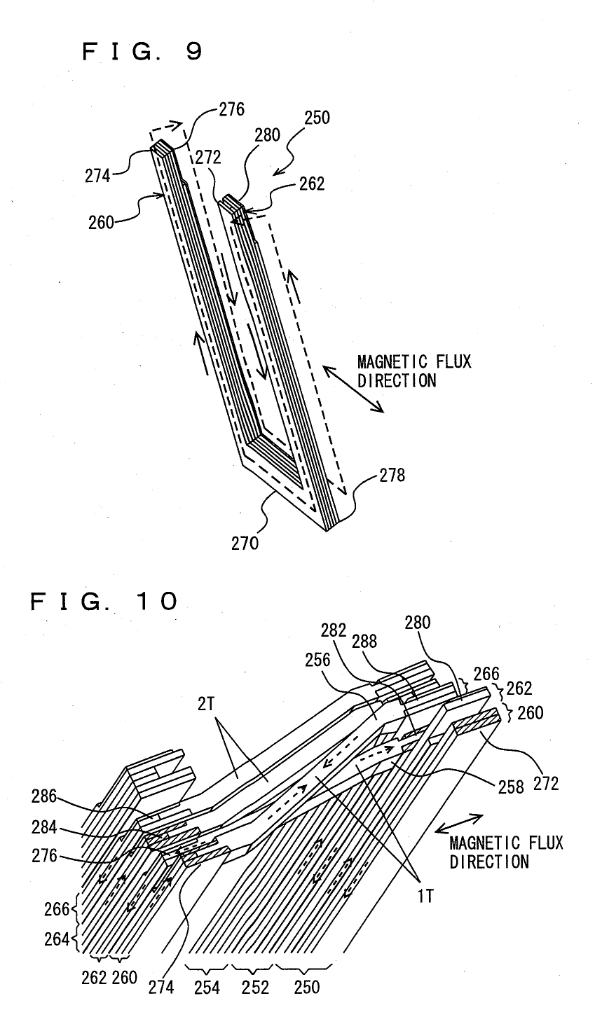

Referring to FIGS. 9 and 10, the function of the stator according to the present embodiment having the above-described structure will be described. Referring to FIG. 10, while the description will be given assuming that transition member 256 is positioned on the axial outward side relative to transition member 258, the same effect can be attained when transition member 258 is positioned on the axial outward side relative to transition member 256.

As shown in FIG. 9, when a leakage flux passes in the circumferential direction in slot 106, in the surface layer portions of two laminated coil plate groups 260 and 262 forming coil plate 250 forming the coil of an identical turn, eddy currents flow (in the directions indicated by solid-line arrows) around the direction in which the magnetic flux passes.

When transition member 256 and bus bar 114 are connected to opposing ends of laminated coil plate groups 260 and 262, the coil plates are connected at their ends also electrically. Therefore, an eddy current flow is formed from one end 272 of laminated coil plate group 260 toward coil end portion 270 in the downward direction in FIG. 9. Furthermore, at coil end portion 270, an eddy current flow is formed from one end 272 side to the other end 274 side. Furthermore, an eddy current flow is formed toward the other end 274 of laminated coil plate group 260 in the upward direction in FIG. 9.

Additionally, an eddy current flow is formed from the other end 274 of laminated coil plate group 260 to one end 276 of laminated coil plate group 262. An eddy current flow is formed from one end 276 of laminated coil plate group 262 toward coil end portion 278 in the downward direction in FIG. 9. Furthermore, at coil end portion 278, an eddy current flow is formed from one end 276 side to the other end 280 side. Furthermore, an eddy current flow is formed from coil end portion 278 toward the other end 280 of laminated coil plate group 262 in the upward direction in FIG. 9. An eddy current flow is formed from the other end 280 of laminated coil plate group 262 to one end 280 of laminated coil plate group 262. Such eddy current flow paths are similarly formed in two laminated coil plate groups 264 and 266 forming coil plate 252. Therefore, detailed description thereof will not be repeated herein.

In this connection, by arranging transition members 256 and 258 to have a crossing shape, as shown in FIG. 10, an eddy current flows in the downward direction in FIG. 10 (the direction indicated by dashed-line arrow), from one end 272, which is the side where transition member 256 is not connected, of laminated coil plate group 260 (of which tip planes are indicated by hatched portions) to coil end portion 270. Furthermore, an eddy current flows via coil end portion 270 toward the other end 274 of laminated coil plate group 260.

Also, an eddy current flows in the downward direction in FIG. 10 (the direction indicated by dashed-line arrow), from one end 276, which is the side where transition member 258 is connected, of laminated coil plate group 262 to coil end portion 278. Furthermore, an eddy current flows via coil end portion 278 toward the other end 280 of laminated coil plate group 262.

Similarly, an eddy current flows in the downward direction in FIG. 10 (the direction indicated by dashed-line arrow), from one end 282, which is the side where transition member 258 is connected, of laminated coil plate group 264 (of which tip planes are indicated by hatched portions) to the coil end portion. Furthermore, an eddy current flows via the coil end portion toward the other end 284 of laminated coil plate group 264.

Also, an eddy current flows in the downward direction in FIG. 10 from one end 286, which is the side where transition member 256 is not connected, of laminated coil plate group 266 to the coil end portion. Furthermore, an eddy current flows via the coil end portion toward the other end 288 of laminated coil plate group 266.

Here, in transition member 256, the eddy current in the direction from end 288 of laminated coil plate group 266 and the eddy current in the direction from end 274 of laminated coil plate group 260 flow. That is, as the crossing shape of transition member 256 and transition member 258 is provided to the stator, in transition member 256, the eddy currents in the directions opposite to each other flow. This allows the eddy currents to be cancelled, and whereby generation of Joule heat is suppressed. Accordingly, the loss by the eddy currents can be suppressed.

As described above, according to the stator for the rotating electric machine of the present embodiment, by providing the two transition members connecting to the laminated coil plate groups of adjacent turns so as to cross each other, it becomes possible to allow an eddy current to flow in the direction from the laminated coil plate groups of one turn toward the transition member, and an eddy current to flow also from the direction from the laminated coil plate group of the other turn toward the transition member. That is, paths can be provided so that the eddy currents from adjacent laminated coil plate groups inserted into different slots can flow in opposite directions relative to each other. Thus, the eddy currents can be cancelled, whereby generation of Joule heat can be suppressed and the loss by the eddy currents can be suppressed.

It is to be noted that, preferably, the crossing shape of the transition members is desirably provided on the rotating shaft center side. This allows cancellation of eddy current flow in a portion where a leakage flux occurs in a large amount, and therefore generation of Joule heat can further be suppressed. Accordingly, the loss by the eddy currents can be suppressed.

While the present embodiment has been applied to the stator including the U-shaped coil plate laminated body, it is not so limited. That is, it may be applied to a stator including an I-shaped coil plate laminated body. Also, it may be applied to a stator including, instead of or in addition to the crossing shape of the transition members, an I-shaped coil plate laminated body which is integrally formed by a combination of two coil plate constituting members each having a portion bent in the front-back direction as seen from the radial direction, as described in the first embodiment. That is, it is only required that at least one of the first and second shapes is applied to the stator.

It should be understood that the embodiments disclosed herein are illustrative and non-restrictive in every respect. The scope of the present invention is defined by the terms of the claims, rather than the description above, and is intended to include any modifications and changes within the meaning and scope equivalent to the terms of the claims.

1. A stator for a rotating electric machine including a rotor and the stator, comprising:
a stator core having a plurality of slots in a direction parallel to a rotating shaft of said rotating electric machine;
a plurality of coil plate laminated bodies each formed in such a manner that a plurality of coil plates each having an insulating member attached to at least one side are laminated in a radial direction; and
connection members connecting the coil plate laminated bodies inserted into different ones of the slots,
said stator having at least one of: a first shape in which at least two of the connection members forming an identical turn are provided so as to cross each other as seen from the direction parallel to said rotating shaft; and a second shape in which each one of said coil plates is formed by integrally combined first member and second member each having a substantially flat shape and being bent in a front-back direction as seen from the radial direction.

2. The stator for the rotating electric machine according to claim 1, wherein
said stator has said second shape, and
said first member and said second member have their respective bent portions positioned near a center between openings at opposing ends of said slot.

3. The stator for the rotating electric machine according to claim 2, wherein
said stator has said second shape, and
said coil plate has at least
a first formation portion where a front-side plane of said first member and a back-side plane of said second member rare in close contact with each other, and
a second formation portion where a back-side plane of said first member and a front-side plane of said second member are in close contact with each other.

4. The stator for the rotating electric machine according to claim 1, wherein
said stator has said first shape,
said coil plate is formed by two sets of laminated coil plate groups formed in such a manner that a plurality of laminated coil plates having substantially same shape as said coil plate as seen from the lamination direction are laminated,
said plurality of connection members are two connection members respectively connected to said two sets of laminated coil plate groups, and
said two connection members respectively connect said laminated coil plate groups and two sets of laminated coil plate groups of an adjacent turn.

5. The stator for the rotating electric machine according to claim 4, wherein
said two connection members are inserted at a position on a center side of said rotating shaft, at least in said slot.

6. The stator for the rotating electric machine according to claim 1, wherein
a coil of an identical turn is formed by said coil plates.

7. The stator for the rotating electric machine according to claim 1, wherein
said coil plates are inserted at a position on a center side of said rotating shaft, at least in said slot.

8. The stator for the rotating electric machine according to claim 1, wherein
an end of said coil plate and an end of said connection member are joined to each other using a paste-like joining material containing a metal nanoparticle coated with an organic substance and an organic solvent.

9. The stator for the rotating electric machine according to claim 8, wherein
said joining material sinters at a temperature lower than a melting temperature of an insulating member used for said stator.

10. The stator for the rotating electric machine according to claim 9, wherein
said metal nanoparticle is a nanoparticle of a metal being one of gold, silver, copper, and platinum.

11. The stator for the rotating electric machine according to claim 1, wherein
said insulating member is one of an insulating film and a coating film of insulation coating.

12. The stator for the rotating electric machine according to claim 1, wherein
said at least two connection members are connection members on a center side of said rotating shaft.
